(19) United States
(12) Patent Application Publication
(10) Pub. No.: US 2019/0309168 A1
(43) Pub. Date: Oct. 10, 2019

(54) Novel Mining Collectors

(71) Applicants: Thomas P. Daly, Arlington Heights, IL (US); Thomas C. Kowalski, Ennis, TX (US)

(72) Inventors: Thomas P. Daly, Arlington Heights, IL (US); Thomas C. Kowalski, Ennis, TX (US)

(21) Appl. No.: 16/374,823

(22) Filed: Apr. 4, 2019

Related U.S. Application Data
(60) Provisional application No. 62/653,298, filed on Apr. 5, 2018.

(51) Int. Cl. C08L 95/00; C08K 5/19; C08K 5/17; A01N 25/30

(52) U.S. Cl. CPC C08L 95/00; C08K 5/19; C08L 2555/60; A01N 25/30; C08K 5/175

(57) ABSTRACT

A family of amine mining collectors that uses alkoxylates allows for the easy adjustment of solubility and molecular weight useful because anionic and cationic mineral collectors require such varying degrees of solubility and molecular weight. The family of the present invention allows for the optimization of both parameters and an increase in collector efficiency.

### BACKGROUND

### Field of the Invention

The present invention relates to the field of fatty amines and more particularly to a class of ether amines.

### Description of the Problem Solved by the Invention

Fatty amines are a versatile group of molecules that are widely used in industrial applications and in personal care and household applications. They are generally used as surfactants. Manufacture of these molecules require a great deal of capital investment in the form of a nitrile reactor. The present invention provides a route to a novel family of amines, including fatty type amine analogs, that do not require a nitrile reactor to manufacture.

### SUMMARY OF THE INVENTION

The present invention relates to the field of amine based surfactants that have a wide range of applications from asphalt emulsifiers, mining collectors to fabric softeners. The invention described here provides a novel way of obtaining molecules with these performance attributes with less capital requirements.

### DESCRIPTION OF THE FIGURES

Attention is now directed to the following figures that describe embodiments of the present invention:

FIG. 1 shows the synthesis of novel ether amine surfactants.

FIG. 2 shows the synthesis of quaternary ammonium compounds.

FIG. 3 shows the synthesis of amine oxides.

FIG. 4 shows the synthesis of polyamines.

FIG. 5 shows the synthesis of polyprimary amines.

FIG. 6 shows the synthesis of highly branched polyamines.

FIG. 7 shows the synthesis of amphoteric surfactants.

FIG. 8 show the synthesis of amine alkoxylates.

FIG. 9-10 shows the synthesis of amine alkoxylate quaternary ammonium compounds.

FIG. 11 shows the synthesis of highly branched amine oxides.

FIG. 12 shows the synthesis of betaine surfactants.

FIG. 13 shows the synthesis of tertiary amines and tertiary polyamines and the quaternary ammonium derivatives.

FIG. 14-15 shows the synthesis of betaines and polybetaines.

### DETAILED DESCRIPTION OF THE INVENTION

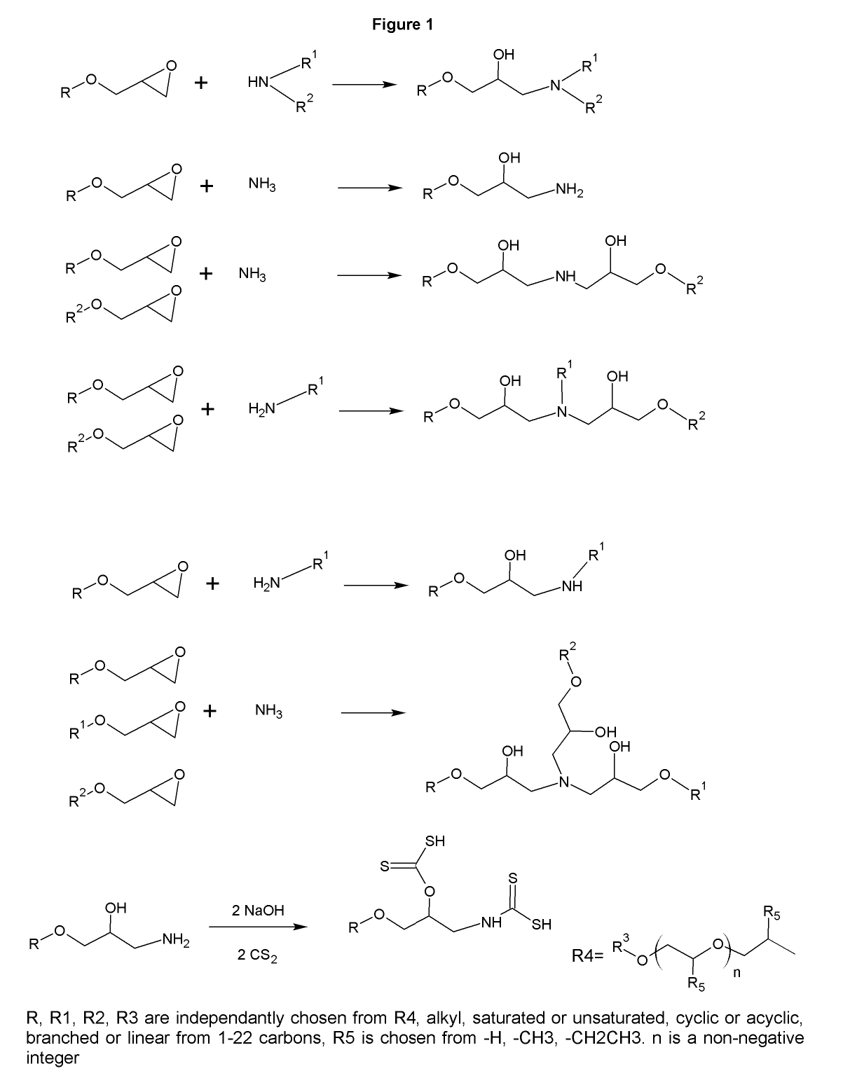

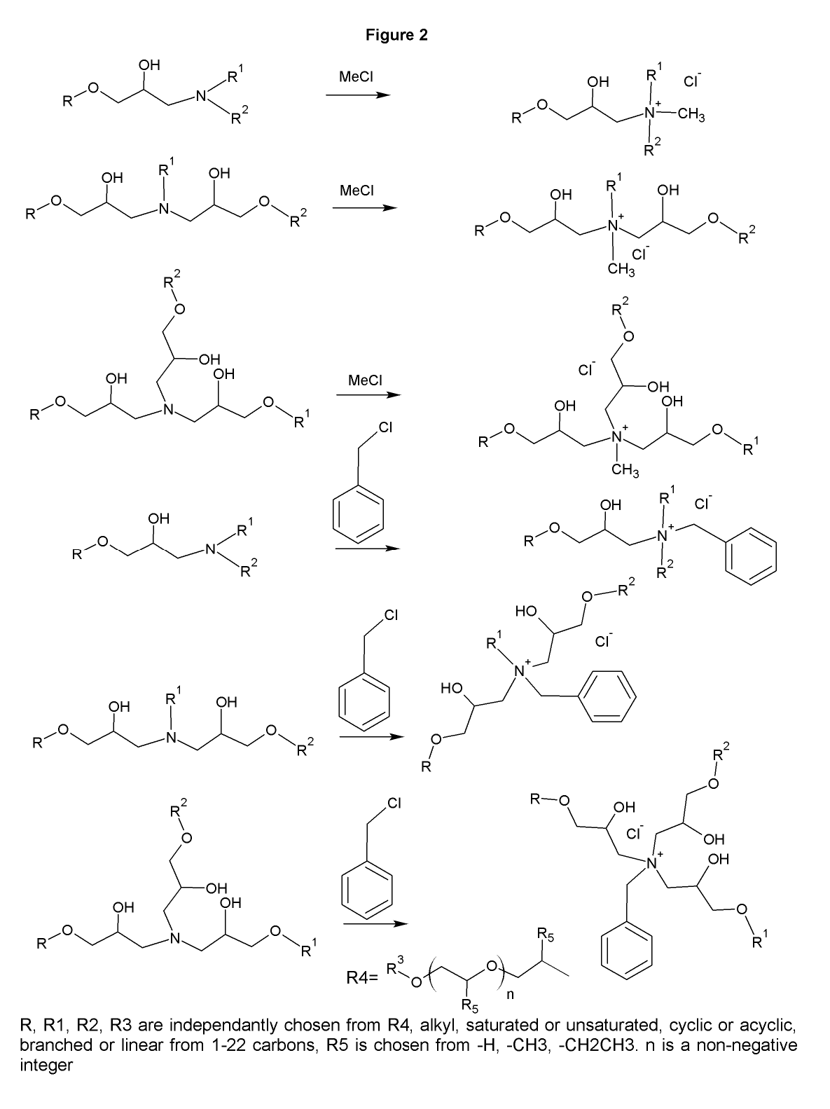

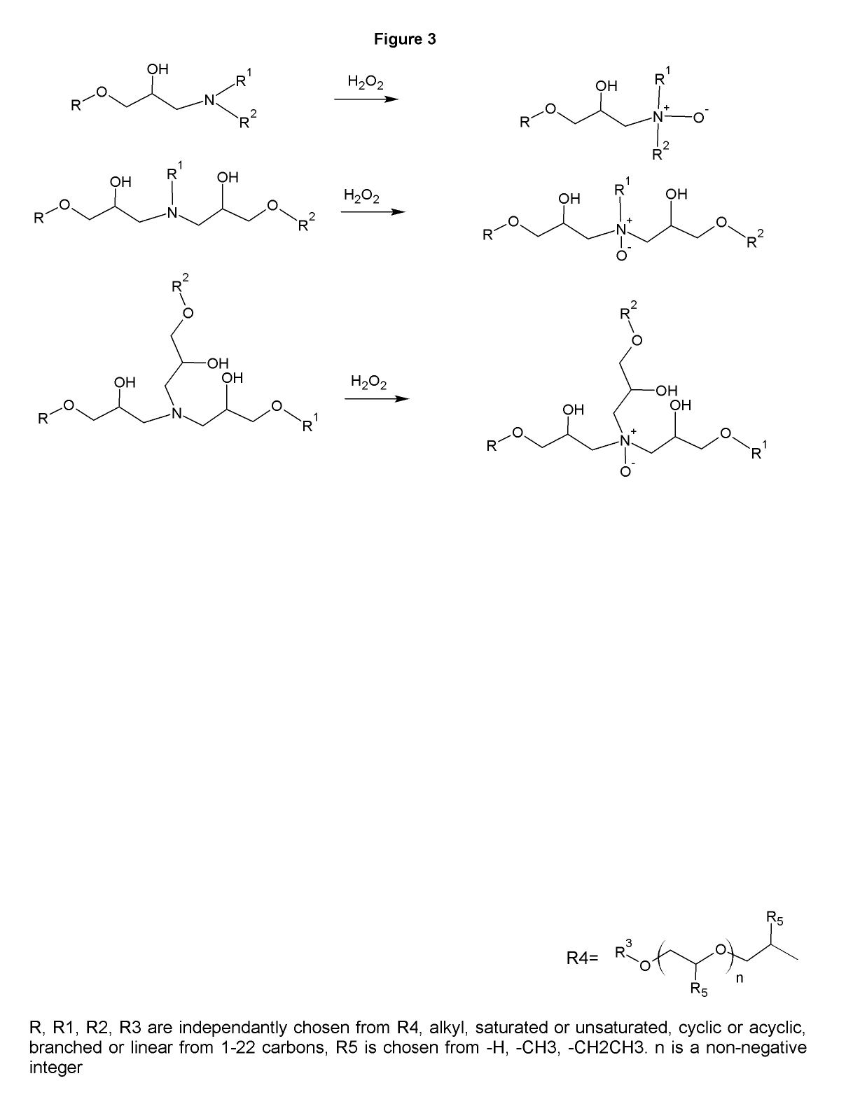

Amines are versatile surfactants that have a wide range of uses. The primary amines of FIG. 1 are useful as mining collectors in iron ore, potash and lithium as well as other minerals where cationic flotation or reverse flotation are practiced. They are also useful when ethoxylated to make agricultural adjuvants. The dithiocarbamates and the dithiocarbamate-xanthate hybrids are useful collectors for sulfide ores, especially those in the pyrite family. FIG. 2 teaches the derivatives of the tertiary amines to quaternary amine salts. The tertiary amines can also be obtained by alkoxylating the primary or secondary amines, then quaternizing. In these cases R¹ and R² will most often be —(CH₂CH₂O)ₙH, or —(CH₂CH(CH₃)O)ₙH, where n is a positive integer, which is the ethoxylated or propoxylated primary or secondary amine, but can be the resulting alkoxylate mono or polymer from any alkoxylating agent, such as butylenes oxide or others, which can be done as a mixture or stepwise to form R¹ and R² as block polymers. The quaternaries shown are of methyl and benzyl quats, but the whole range of quats are possible and included in the scope of this invention, including, but not limited to naphthalene chloride, ethyl benzyl chloride, ethyl sulfate, and methyl sulfate type quats. These surfactants are useful as hair conditioners, fabric softeners, and hard surface cleaners and disinfectants, as well as corrosion inhibitors in industrial applications from metal working fluids, greases and in oil wells and pipelines. FIG. 3 teaches the synthesis of amine oxides. These high foaming cleaners are great detergents and foaming agents. They are useful in household and industrial cleaning applications as well as foamers for downhole oil well stimulation.

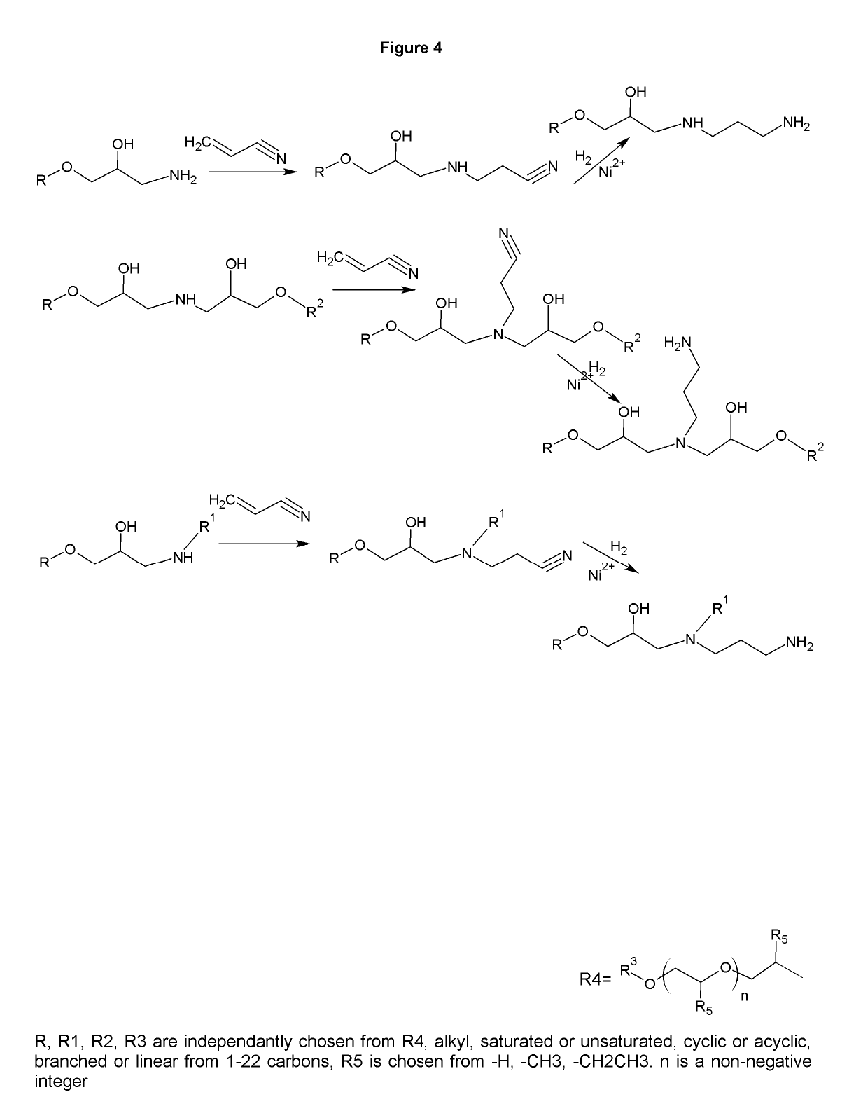

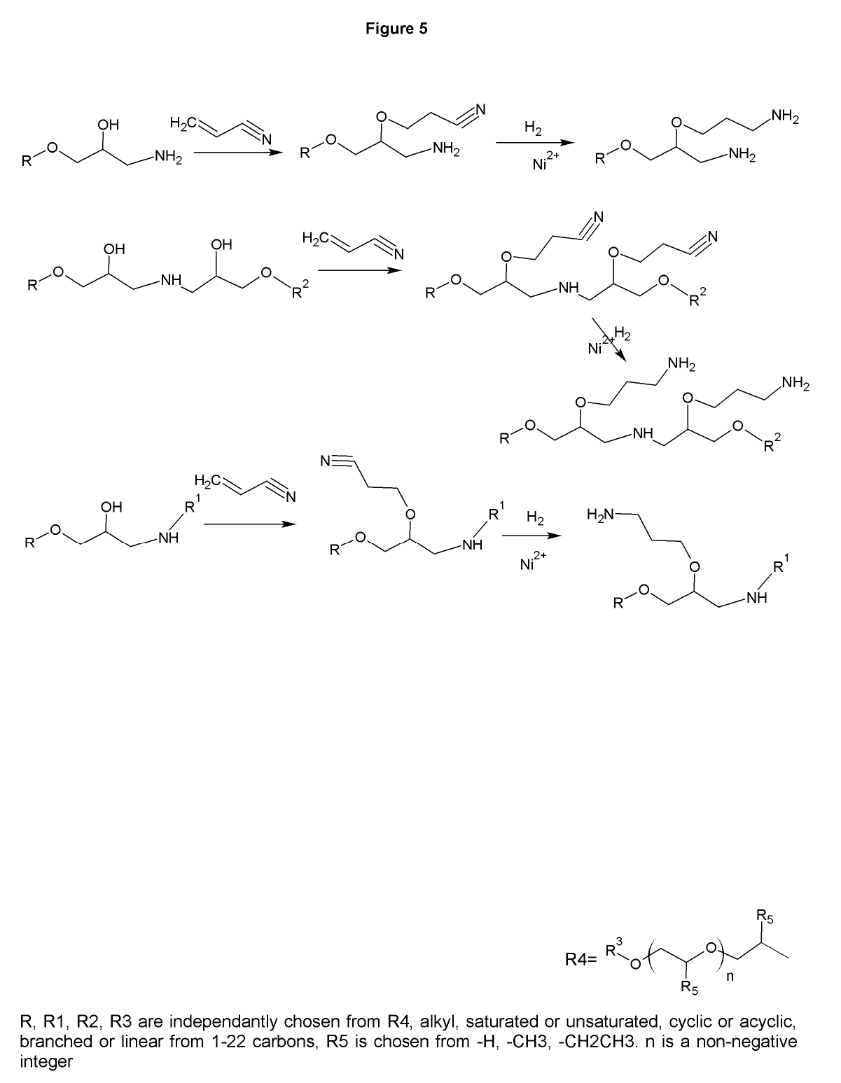

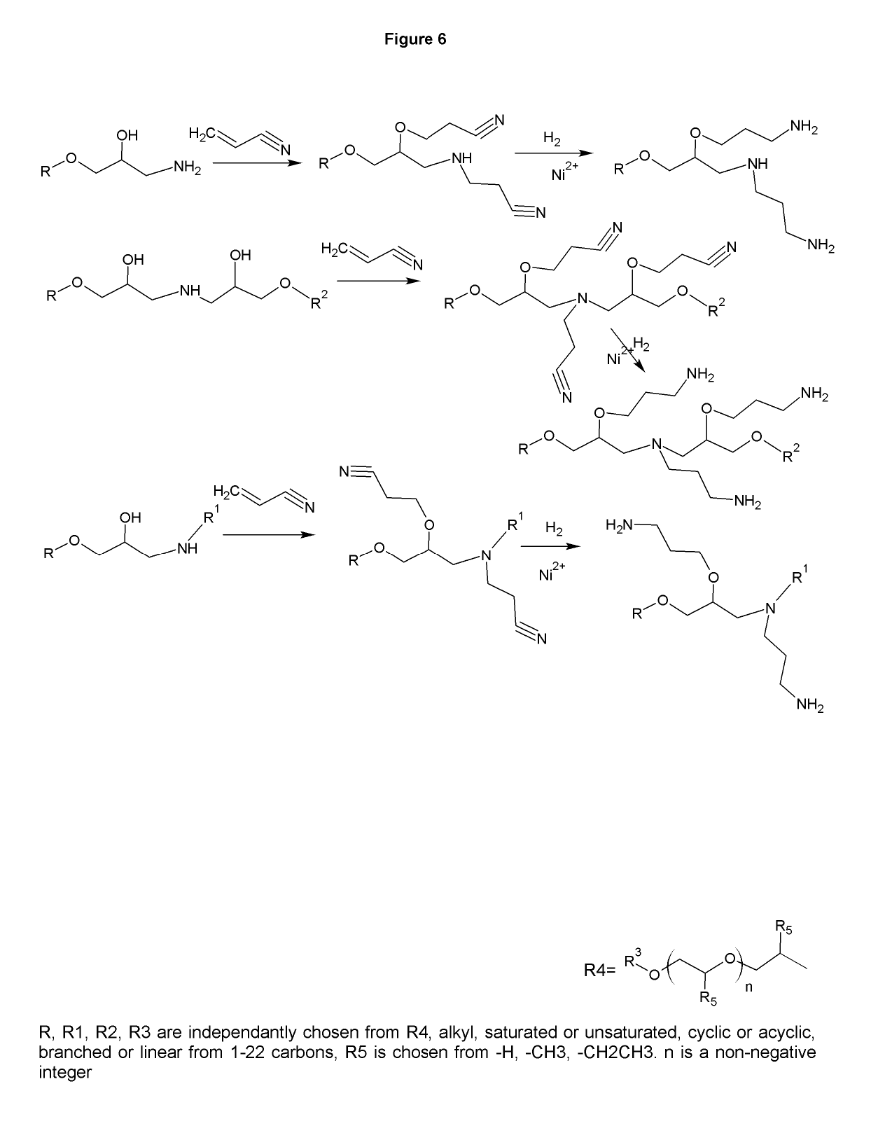

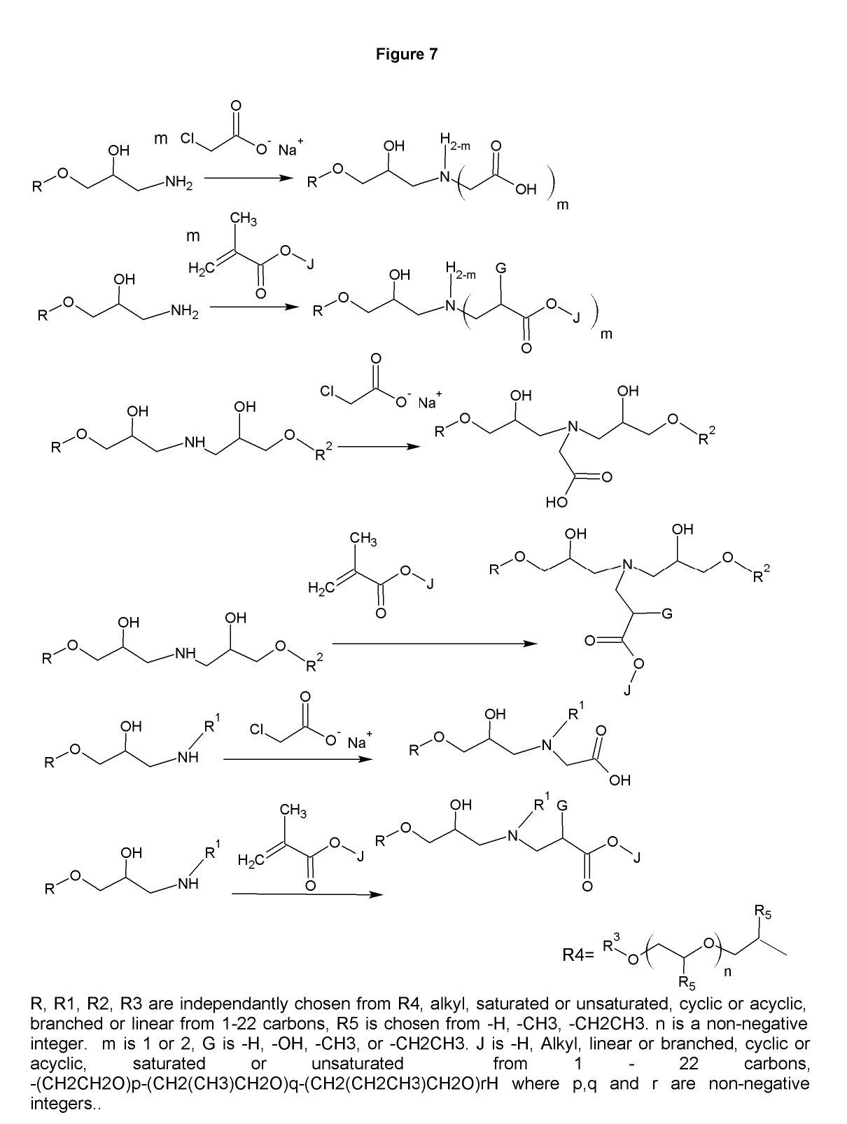

FIG. 4 teaches the synthesis of polyamines based on the amines of FIG. 1. These polyamines have utility as asphalt emulsifiers, mining collectors, as well as corrosion inhibitors. FIG. 5-6 teaches the branched polyamines which are useful as overhead corrosion inhibitors in refineries as well as tertiary cross linking of urea polymers or urethane/urea polymers. FIG. 7 teaches the synthesis of amphoteric surfactants. These amphoteric surfactants are effective across a wide pH range and are mild to the skin. They are also able to withstand high levels of hard water ions and still provide strong foam.

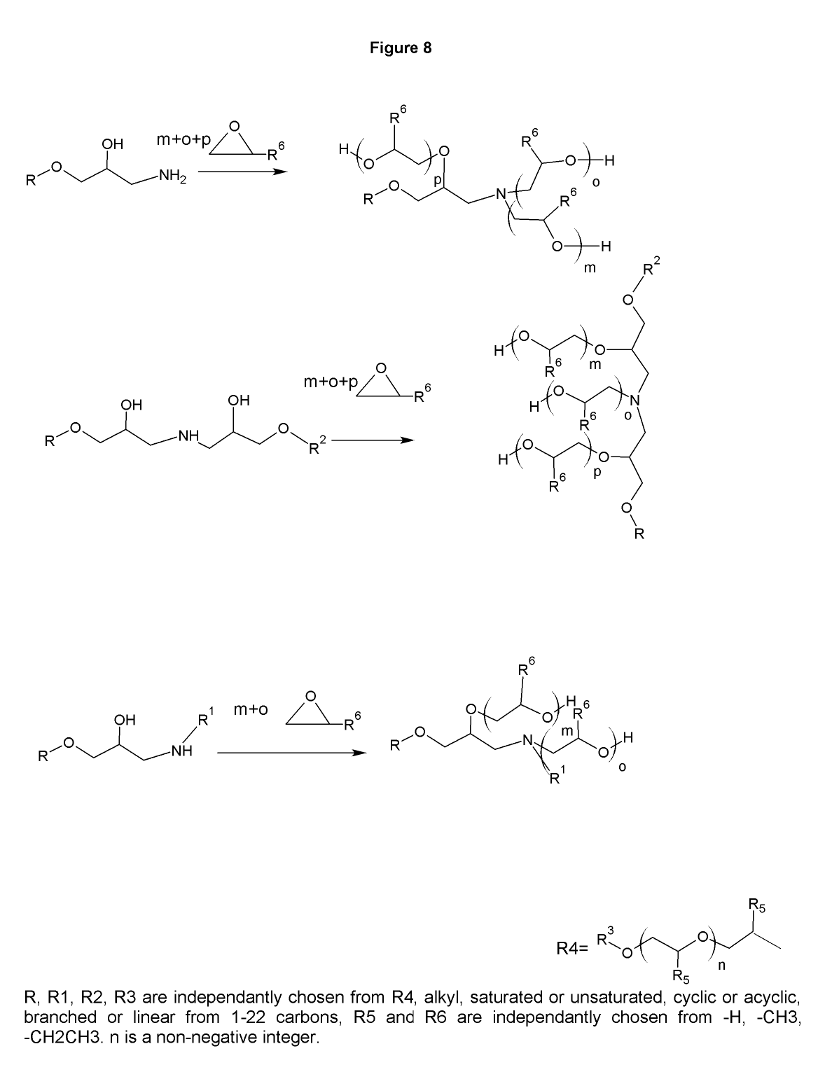

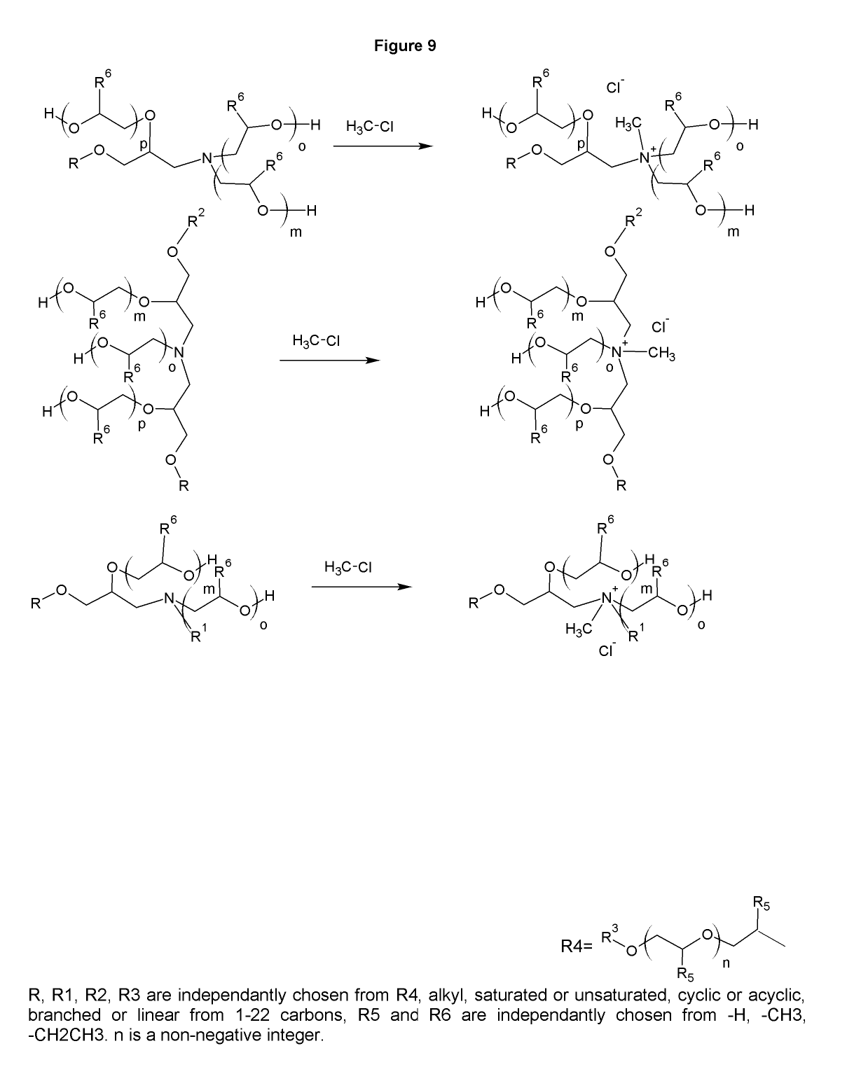

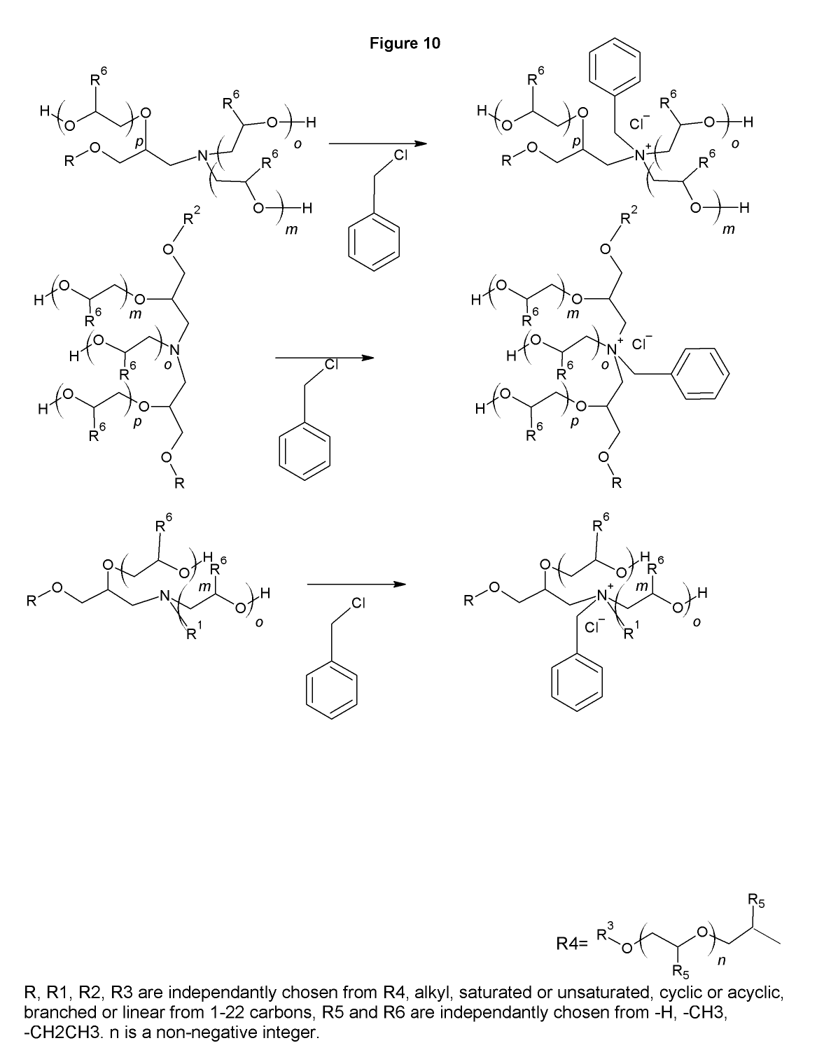

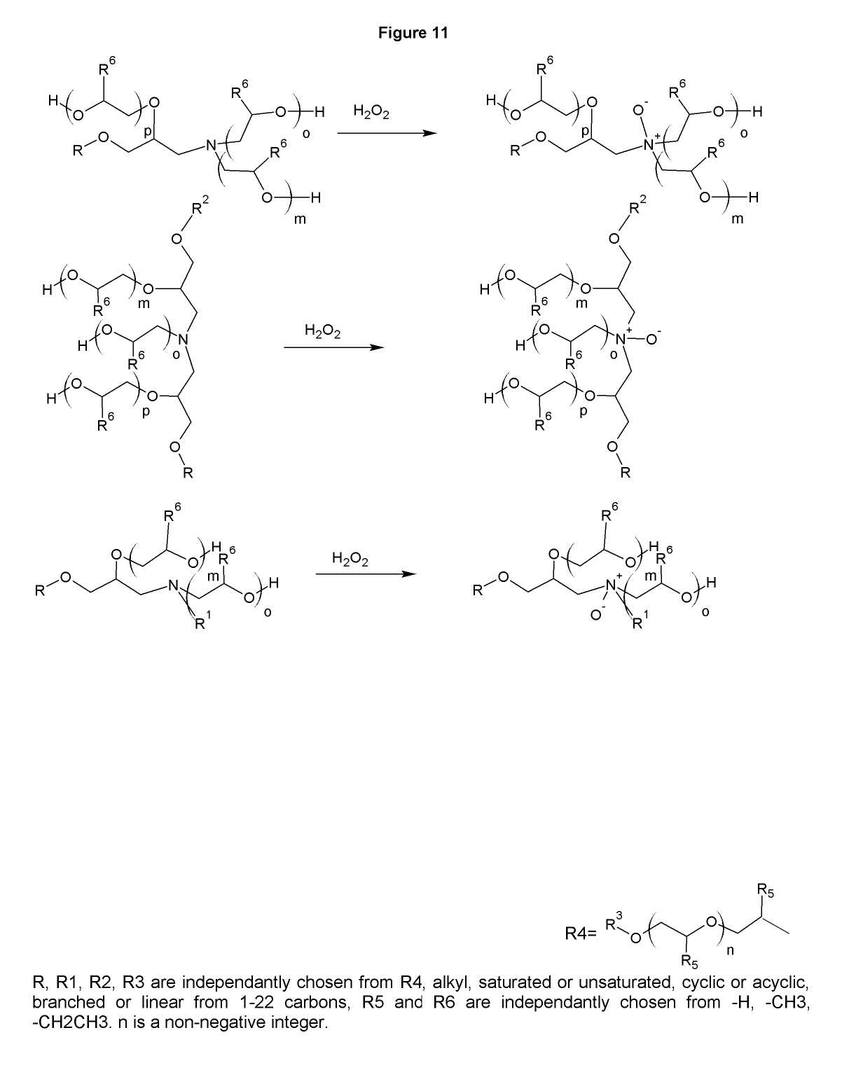

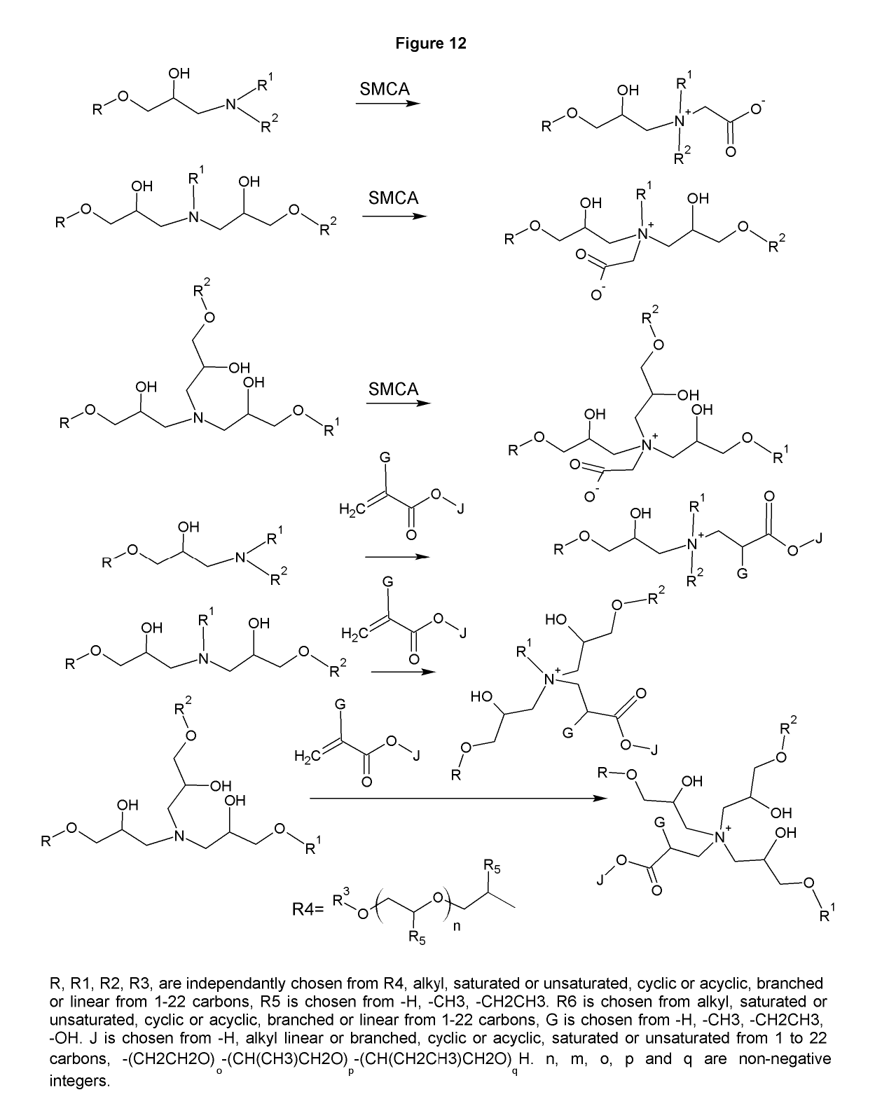

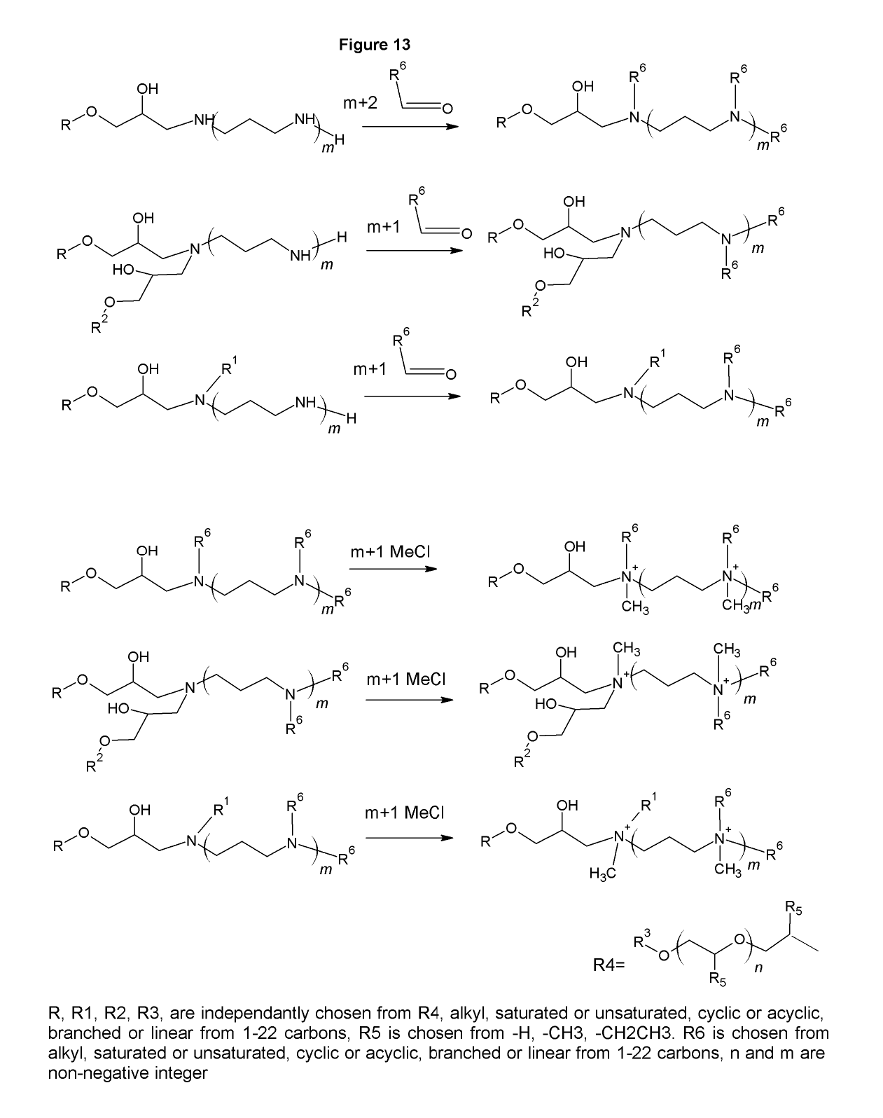

FIG. 8 teaches the synthesis of the alkoxylates of the primary and secondary amines and polyamines. The alkoxylates of FIG. 8 can be made to specific HLB values based on the amount of and the type of alkoxylating agent(s). The use of blends or stepwise reaction with ethylene oxide, propylene oxide and butylene oxide allows for adjustment of the HLB and a wide range of properties, including emulsification and demulsification. The largest applciation is the ethoxylation between 10 and 20 moles of EO for agricultural adjuvants and spreaders. The lower alkoxylates are useful as power improvers in oil pipeline and corrosion inhibition. FIGS. 9 and 10 show the quaternization of the alkoxylated amines and polyamines which are useful as corrosion inhibitors and cationic surfactants that are less susceptible to pH than the underlying amines. FIG. 11 shows the amine oxide derivatives of the alkoxylated amines and polyamines. These again are strong foamers for household and industrial applications. FIGS. 12 and 13 teaches the synthesis of betaines and polybetaines. These products are useful as mild detergents and shampoos. Additionally, the polybetaines are excellent for emulsifying difficult asphalt. The quaternaries and polyquaternaries, similar to those of FIG. 2 can be made by quaternizing the tertiary amines with a range of quaternizing agents, including, but not limited to methyl chloride, benzyl chloride, naphthalene chloride, ethyl benzyl chloride, ethyl sulfate, and methyl sulfate or any other quaternizing agent.

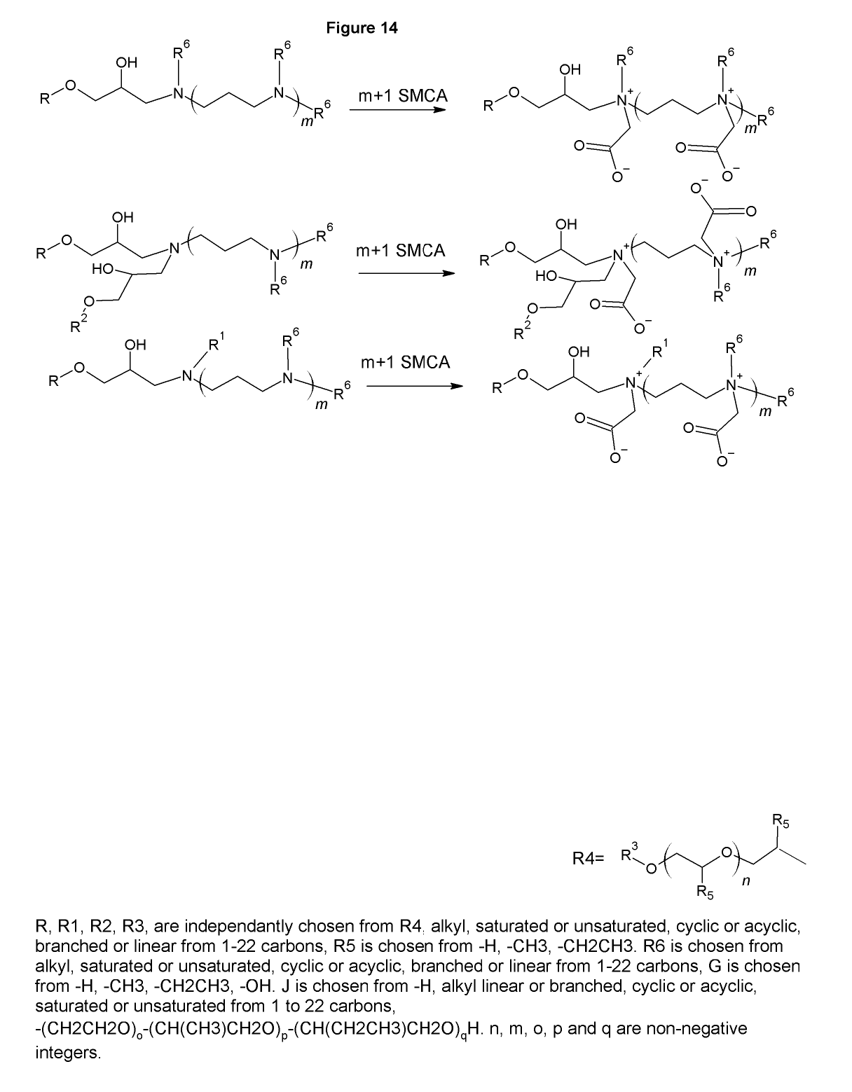

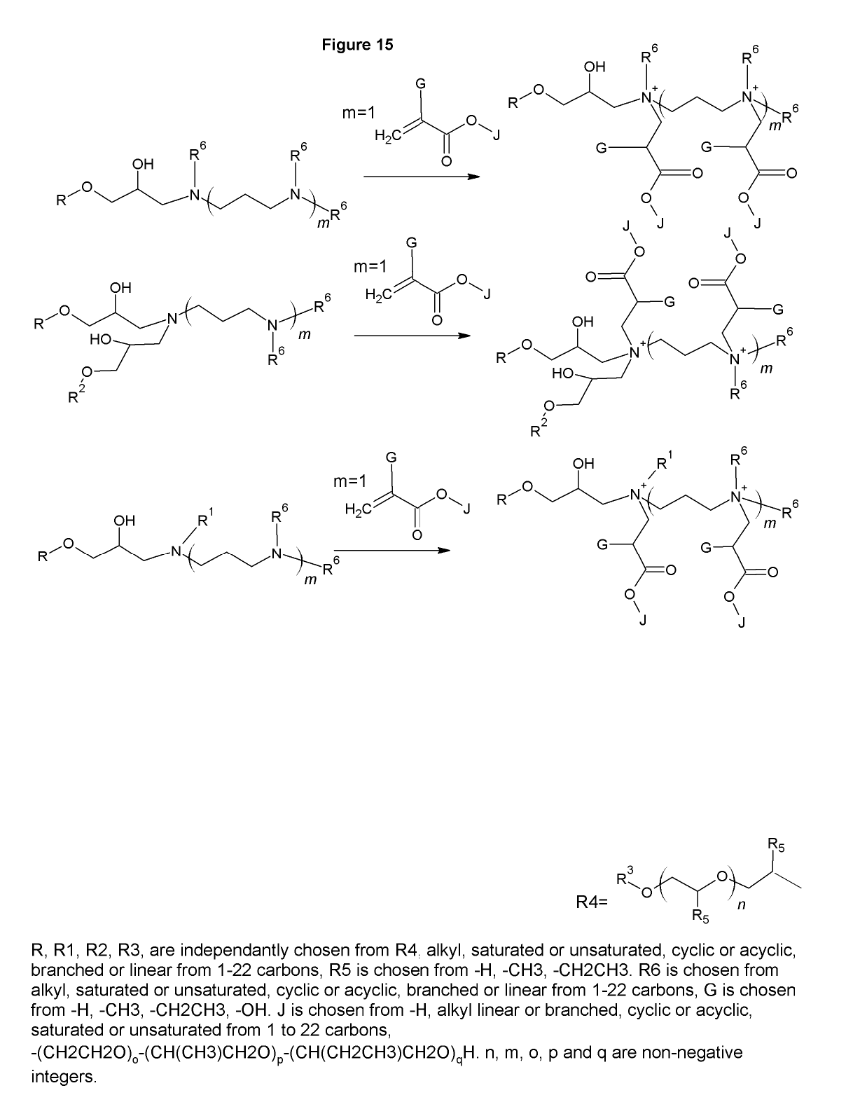

FIG. 14 further expands on the polybetaines, as does FIG. 15. These compounds are important surfactants in industrial applications where strong surfactancy is required. They are also mild enough for personal care applications.

Several descriptions and illustrations have been presented to enhance understanding of the present invention. One skilled in the art will know that numerous changes and variations are possible without departing from the spirit of the invention. Each of these changes and variations are within the scope of the present invention.

1-6. (canceled)

7. The surfactant and its relevant salts of the following structure: 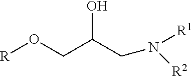
where R¹, and R² are independently chosen from —CH2-CH(OH)CH2O—R⁶, alkyl, saturated or unsaturated, cyclic or acyclic, branched or linear from 1-22 carbons, R and R⁶ are independently chosen from alkyl, saturated or unsaturated, cyclic or acyclic, branched or linear from 1-22 carbons.

8. The surfactant and its relevant salts of claim 7 where R=alkyl C₁₂, R¹═—CH₂—CH(OH)CH₂O—R⁶, where R⁶═alkyl C₁₄, R²═—CH₃.

9. The Surfactant and its relevant salts of the following structure: 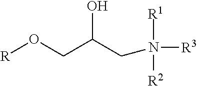
where R¹, and R² are independently chosen from —CH2-CH(OH)CH2O—R⁶, alkyl, saturated or unsaturated, cyclic or acyclic, branched or linear from 1-22 carbons, —(CH2CH2O)ₚH—(CH(CH3)CH2O)_{q}H—(CH(CH2CH3)CH2O)ᵣH, R¹ and R⁶ are independently chosen from alkyl, saturated or unsaturated, cyclic or acyclic, branched or linear from 1-22 carbons. R³ is selected from —O⁻, alkyl of 1-22 carbon atoms, —CH₂COOH, —CH₂CH₂COOH, —CH(CH₃)COOH, —CH₂—C₆H₆, —CH(CH₂CH₃)—C₆H₆, —O⁻, p, q and r are non-negative integers.

10. The salt of the surfactant of claim 9 where R¹═—CH₂—CH(OH)CH₂O—R⁶, R²═R³═—CH₃.

11. The salt of the surfactant of claim 9 where R=alkyl C₁₂, R¹═—CH₂—CH(OH)CH₂O—R⁶, where R⁶=alkyl C₁₄, R²═R³═—CH₃.

12. The salt of the surfactant of claim 9 where R=alkyl C₁₂, R¹═—CH₂—CH(OH)CH₂O—R⁶, where R⁶=alkyl C₁₂, R²═R³═—CH₃.

13. The salt of the surfactant of claim 9 where R=alkyl C₁₄, R¹═—CH₂—CH(OH)CH₂O—R⁶, where R⁶=alkyl C₁₄, R²═R³═—CH₃.

14. The salt of the surfactant of claim 9 where R=alkyl C₁₆, R¹═—CH₂—CH(OH)CH₂O—R⁶, where R⁶=alkyl C₁₈, R²═R³═—CH₃.

15. The salt of the surfactant of claim 9 where R=alkyl C₁₈, R¹═—CH₂—CH(OH)CH₂O—R⁶, where R⁶=alkyl C₁₈, R²═R³═—CH₃.

16. The surfactant of claim 9 where R¹═—CH₂—CH(OH)CH₂O—R⁶, R²═—CH₃, and R³═—O⁻.

17. The surfactant of claim 9 where R=alkyl C₁₂, R¹═—CH₂—CH(OH)CH₂O—R⁶, where R⁶=alkyl C₁₄, R²═—CH₃, and R³═—O⁻.

18. The surfactant of claim 9 where R¹═—CH₂—CH(OH)CH₂O—R⁶, R²═—CH₃, and R³═—O⁻.

19. The surfactant and its relevant salts of claim 9 where R=alkyl C₁₂, R¹═—CH₂—CH(OH)CH₂O—R⁶, where R⁶=alkyl C₁₄, R²═—CH₃, and R³═—CH₂CH₂COOH.

20. The surfactant and its relevant salts of claim 9 where, R¹═—CH₂—CH(OH)CH₂O—R⁶, R²═—CH₃, R³═—CH₂CH₂COOH.

21. The surfactant and its relevant salts of claim 9 where R¹═—CH₂—CH(OH)CH₂O—R⁶, R²═—CH₃, and R³═—CH₂—C₆H₆.

22. The surfactant and its relevant salts of claim 9 where R¹═R²═—CH₃, and R³═—CH₂—C₆H₆.

23. The surfactant and its relevant salts of claim 9 where R=Alkyl C₁₂, R¹═R²═—CH₃, and R³═—CH₂—C₆H₆.

24. The surfactant and its relevant salts of claim 9 where R=Alkyl C₁₄, R¹═R²═—CH₃, and R³═—CH₂—C₆H₆.

25. The surfactant and its relevant salts of claim 9 where R=Alkyl C₁₆, R¹═R²═—CH₃, and R³═—CH₂—C₆H₆.

26. The surfactant and its relevant salts of claim 9 where R=Alkyl C₁₈, R¹═R²═—CH₃, and R³═—CH₂—C₆H₆.
